(19) United States
(12) Patent Application Publication
(10) Pub. No.: US 2010/0134317 A1
(43) Pub. Date: Jun. 3, 2010

(54) METHOD FOR CONFIGURING A WIRELESS COMMUNICATION DEVICE AS A REMOTE CONTROL, REMOTELY CONTROLLABLE ELECTRONIC DEVICE AND WIRELESS COMMUNICATION DEVICE

(75) Inventors: Cyril Breuil, Surrey (GB); Joël Simon, Surrey (GB)

Correspondence Address: HOGAN & HARTSON LLP, ONE TABOR CENTER, SUITE 1500, 1200 SEVENTEENTH ST, DENVER, CO, 80202, US

(73) Assignee: ST-Ericsson SA, Geneva (CH)

(21) Appl. No.: 12/524,850

(22) PCT Filed: Jan. 28, 2008
(86) PCT No.: PCT/IB2008/050299

§ 371 Date: Feb. 2, 2010

(30) Foreign Application Priority Data
Feb. 1, 2007 (EP) 07290135.8

(51) Int. Cl. G08C 19/28

(52) U.S. Cl. 340/825.69

(57) ABSTRACT

A method of configuring a wireless communication device operable as a remote control of an electronic device includes storing a pointer to a remote source in the electronic device, the remote source including control software for enabling the wireless communication device to remotely control the electronic device. The method also includes establishing a communication link between the electronic device and the wireless communication device, communicating the pointer from the electronic device to the wireless communication device, connecting the wireless communication device to the remote source, and installing the control software on the wireless communication device. The application further discloses an electronic device comprising such a pointer and a wireless communication device for receiving such a pointer.

The present invention relates to a method configuring a wireless communication device such that the wireless communication device can become operable as a remote control of an electronic device.

The present invention further relates to a remotely controllable electronic device, and to a wireless communication device for remotely controlling such an electronic device.

Modern work and living environments harbour a plethora of electronic devices that can be remotely controlled, for instance by means of line-of-sight, e.g. infrared, devices or by mobile communication devices using wireless communication standards, e.g. Bluetooth, for communicating control instructions. Such electronic devices include consumer electronic devices such as TVs, DVD or CD players, set top boxes, recording devices and so on, as well as domestic appliances such as refrigerators and washing machines. It is inconvenient to have to use dedicated remote control devices for all of these electronic devices. For this reason, many efforts have been made to provide wireless electronic devices that can operate as universal remote controllers. Recently, these efforts have included extending the functionality of wireless communication devices, e.g. mobile phones or personal digital assistants (PDAs), such that these devices can operate as a remote controller for the aforementioned remotely controllable electronic devices.

The main technical problem associated with universal remote controllers is how to configure the remote controller such that the remote controller can provide the correct control signals of an unknown electronic device to be controlled. One known method is to have the remote control provide a series of trial signals to the electronic device and observe the response of the electronic device to the trial signals. The responses teach the remote controller which signals belong to which function of the electronic device. Consequently, the generation of these signals is linked to the appropriate function keys of the remote controller. This method is suitable for providing a mapping of basic functions of the electronic device to the remote controller, but typically fails to provide remote control over more complex functionality of an electronic device, e.g. the programming of a recording on a set-top box.

UK patent application GB 2,370,899 discloses a method for controlling an electronic device with a mobile phone using hypertext or hypermedia communication capabilities. The electronic device can provide the mobile phone with programming data for controlling the electronic device. This method has the drawback that the mobile phone must be extended with hypertext or hypermedia communication capabilities, and that relatively large amounts of data have to be communicated between the electronic device and the mobile phone.

On http://shop.psiloc.com/en/Application,65545,Psiloc+Total+irRemote, retrieved from the internet on Jan. 2, 2007, a method is disclosed to extend the functionality of a Symbian based smart phone to remotely control an electronic device by downloading the control software for the electronic device from an internet source. A problem associated with this method is that the list of electronic devices for which control software is available is limited, which means that for some electronic devices no control software is available.

U.S. 2003/0156053 discloses a PDA that can be used as a universal remote controller. The control software for controlling an electronic device can be downloaded from the website of the manufacturer of the electronic device. Alternatively, the control software is provided with the electronic device. JP 2002/186063 discloses a mobile phone configurable as a remote controller by downloading the control software for remotely controlling an electronic device from a specified internet location onto the mobile phone. These approaches have the drawback that the user of the mobile communication device has to personally retrieve the control software, which can be cumbersome if manufacturer specified internet location comprises a large number of control software programs, which can lead to the user of the mobile communication device being unable to find the correct control software or selecting the wrong control software.

The present invention seeks to provide a method according to the opening paragraph that reduces the amount of user interaction required to configure the mobile communication device.

The present invention further seeks to provide a remotely controllable electronic device that allows configuration of a mobile communication device as its remote controller with limited user interaction.

The present invention yet further seeks to provide a wireless communication device that can be easily configured as a remote controller.

According to an aspect of the present invention, there is provided a method of configuring a wireless communication device such that the wireless communication device can become operable as a remote control of an electronic device, the method comprising storing a pointer to a remote source in the electronic device, the remote source comprising control software for enabling the wireless communication device to remotely control the electronic device; establishing a communication link between the electronic device and the wireless communication device; communicating the pointer from the electronic device to the wireless communication device; connecting the wireless communication device to the remote source; and installing the control software on the wireless communication device.

By making a pointer such as a uniform resource locator (URL) available on the electronic device to be remotely controlled, the user of the wireless communication device only has to bring the wireless communication device within communication range of the electronic device, after which the control software may be automatically downloaded onto the wireless communication device, e.g. from the internet. This may be realized by establishing a wireless internet connection between the wireless communication device and an internet server and downloading the control software directly onto the wireless communication device or by connecting the wireless communication device to an internet-enabled further electronic device such as a personal computer via an interface, e.g. a USB port.

According to another aspect of the present invention, there is provided remotely controllable electronic device comprising a data storage element comprising a pointer to a remote source comprising control software for enabling a wireless communication device to remotely control the electronic device, the electronic device being arranged to communicate the pointer to the wireless communication device upon establishing a communication link between the electronic device and the wireless communication device.

Such an electronic device has the advantage that the control software for its remote control can be retrieved from the remote source such as the internet with minimal user interaction.

According to yet another aspect of the present invention, there is provided a wireless communication device for controlling the electronic device of the present invention, the wireless communication device comprising means for establishing a communication link with the electronic device; means for receiving the pointer over the communication link; means for facilitating the retrieval of the control software from the remote source; and a memory for storing the control software.

Such a wireless communication device has the advantage that the control software for controlling the electronic device of the present invention can be retrieved from the remote source such as the internet with minimal user interaction.

The invention is described in more detail and by way of non-limiting examples with reference to the accompanying drawings, wherein:

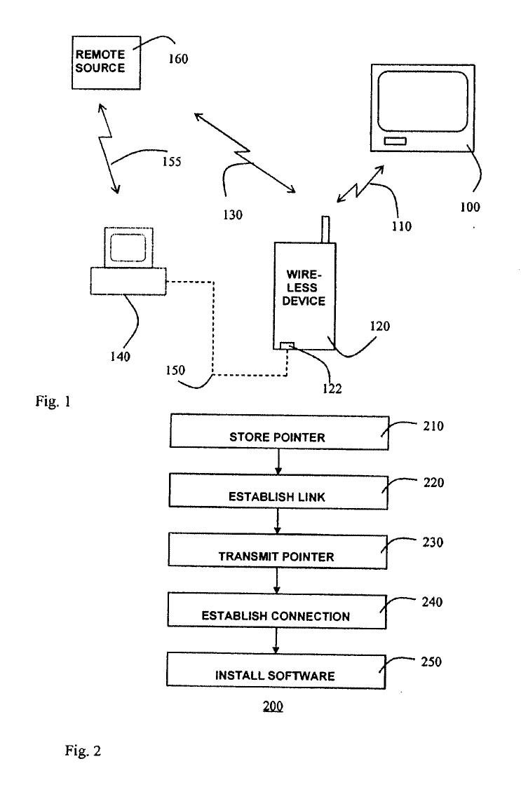

FIG. 1 depicts an embodiment of the method and the devices of the present invention; and

FIG. 2 depicts a flowchart of an embodiment of the method of the present invention.

It should be understood that the Figures are merely schematic and are not drawn to scale. It should also be understood that the same reference numerals are used throughout the Figures to indicate the same or similar parts.

FIG. 1 depicts an implementation of the method of the present invention involving an electronic device 100 and a wireless communication device 120 of the present invention. FIG. 1 will be described in combination with FIG. 2. The electronic device 100 may be any electronic device such as a consumer electronic device or a domestic appliance that can be remotely controlled. The electronic device 100 has a data storage element (not shown) such as a read-only memory or another suitable data storage element in which a pointer to a remote source 160 is stored. This step is depicted as step 210 in FIG. 2.

The remote source 160 comprises control software for remotely controlling the electronic device 100. The pointer preferably is a uniform resource locator (URL) directing to an internet address on which the manufacturer of the electronic device 100 has made the control software available, but alternative pointers are equally feasible. The electronic device 100 is configured to output the pointer via a communication link 110 upon request.

Such a request may be provided by the wireless communication device 120 of the present invention, which may for instance be a mobile phone or a PDA. Alternatively, it may be any universal remote control that can be directly or indirectly connected to the remote source 160. The wireless communication device 120 is configured to establish a communication link 110 with the electronic device 100. This step is depicted as step 220 in FIG. 2. Such communication links are known per se and will therefore not be further discussed in detail for the sake of brevity. It will be understood that known communication protocols such as near-field communication techniques, wireless LAN or Bluetooth may be used to establish the communications link 110. In the case of the use of near-field communication techniques, the datastorage element of the electronic device 100 storing the pointer may be an RF-ID tag, which may be activated by an RF signal from the wireless communication device 120.

The communication link 110 may be established in response to a user instructing the wireless communication device 120 that the control software for an electronic device 100 to be remotely controlled has to be added to the wireless communication device 120. The user-driven establishment of such a link avoids unnecessary establishment of such links, e.g. in a situation where the wireless communication device 120 already comprises the necessary control software. The establishment of the communication link triggers the electronic device 100 to transmit the pointer to the remote source 160 to the wireless communication device 120. This step is depicted as step 230 in FIG. 2.

The electronic device 100 may be configured to send the pointer in combination with an identifier identifying the electronic device. This is advantageous if multiple electronic devices 100 of the present invention that are within range of the wireless communication device 120 respond to the attempts of the wireless communication device 120 to set up a communication link, because the respective identifiers can be used to distinguish between the different electronic devices 100. Moreover, the identifier can be used to configure the user interface of the wireless communication device 120, e.g. by inserting the identifier in a selection menu for selecting an electronic device to be remotely controlled by the wireless communication device 120.

The identifier may further serve the purpose of avoiding unnecessary communication between a wireless communication device 120 and an electronic device 100 of which the wireless communication device 120 already has control software installed. To this end, the identifier may be compared with a list of identifiers stored on the wireless communication device 120, and in case the received identifier is present in the list, no attempts will be made to retrieve the control software from the remote source 160. In case no identifier is provided, the pointer may remain stored on the wireless communication device 120 to facilitate a check of whether or not the corresponding control software has already been installed on the wireless communication device 120.

In the next step 240, the wireless communication device 120 establishes a connection with the remote source 160. Subsequently, the wireless communication device 120 downloads the control software from the remote source 160 and installs the control software, e.g. by storing it in its program memory (not shown). This step is depicted as step 250 in FIG. 2.

Step 240 may be implemented in a number of ways. In an embodiment, the wireless communication device 120 is configured to directly establish a communication link 130 with the remote source 160. For instance, the wireless communication device 120 may be internet-enabled, e.g. a WAP or 3G mobile phone or PDA, with the pointer being an URL and the remote source 160 being an internet location storing the control software.

Alternatively, the wireless communication device 120 may be connected to a further electronic device 140 for retrieving the control software from the remote source 160 via a communications link 155. For instance, the further electronic device 140 may be a personal computer, which is configured to access the internet and connect to remote source 160 upon establishment of a connection 150 with the wireless communication device 120. The connection 150 may be a wireless connection, e.g. a wireless LAN or Bluetooth connection, or may be a wired connection using a cable inserted into a socket 122 of the wireless communication device 120.

The further electronic device 140 may comprise dedicated software that configures the further electronic device 140 to automatically extract the pointer from the wireless communication device 120, to automatically retrieve the control software from the remote source 160 and forward the control software to the wireless communication device 120. Such dedicated software may be provided by the manufacturer of the wireless communication device 120.

The wireless communication device 120 may be further configured to keep the pointer stored in a memory (not shown) together with a date tag to facilitate periodic checks for updates of the control software. To this end, the wireless communication device 120 may be configured to periodically connect to the remote source 160 to check for updates of the control software. Alternatively, such update functionality may be included in the aforementioned dedicated software for the further electronic device 140.

It will be appreciated that if more than one electronic device 100 is within range of the wireless communication device 120 when attempting the retrieval of the pointer from the electronic device 100, more than one pointer may be retrieved, and more than one remote source 160 may be connected to retrieve the respective control software for controlling the respective electronic devices 100. To avoid interference between the data communication links 110 in such a situation, known collision avoidance techniques may be employed.

It will also be appreciated that the various parts of the wireless communication device 120 of the present invention such as the means for establishing a communication link 110 with the electronic device 100, the means for receiving the pointer over the communication link 110; and the means for facilitating the retrieval of the control software from the remote source 160 have not been described in detail because these means can be routinely implemented by the person skilled in the art.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements. In the device claim enumerating several means, several of these means can be embodied by one and the same item of hardware. The mere fact that certain measures are recited in mutually different dependent claims does not indicate that a combination of these measures cannot be used to an advantage.

1. A method of configuring a wireless communication device operable as a remote control of an electronic device, the method comprising:
storing a pointer to a remote source in the electronic device, the remote source comprising control software for enabling the wireless communication device to remotely control the electronic device;
establishing a communication link between the electronic device and the wireless communication device;
communicating the pointer from the electronic device to the wireless communication device;
connecting the wireless communication device to the remote source; and
installing the control software on the wireless communication device.

2. A method as claimed in claim 1, wherein the pointer comprises a uniform resource locator.

3. A method as claimed in claim 2, wherein the step of connecting the wireless communication device to the remote source comprises:
providing a further communication device for communicating with the remote source;
providing an interface for interfacing between the wireless communication device and the further communication device; and
connecting the wireless communication device to the remote source via the interface and the further communication device.

4. A remotely controllable electronic device comprising a data storage element comprising a pointer to a remote source, the remote source comprising control software for enabling a wireless communication device to remotely control the electronic device, the electronic device being arranged to communicate the pointer to the wireless communication device upon establishing a communication link between the electronic device and the wireless communication device.

5. An electronic device as claimed in claim 4, wherein the pointer is a uniform resource locator.

6. A wireless communication device for controlling the electronic device as claimed in claim 5, the wireless communication device comprising:
means for establishing a communication link with the electronic device;
means for receiving the pointer over the communication link;
means for facilitating the retrieval of the control software from the remote source; and
a memory for storing the control software.

7. A wireless communication device as claimed in claim 6, wherein the means for facilitating the retrieval of the control software from the remote source comprise internet connection means.

8. A wireless communication device as claimed in claim 6, wherein the means for facilitating the retrieval of the control software from the remote source comprise an interface for connecting the wireless communication device to a further electronic device operative to receive the pointer through the interface, to retrieve the control software from the remote source and to provide the wireless communication device with the control software.

9. A wireless communication device for controlling the electronic device as claimed in claim 4, the wireless communication device comprising:
means for establishing a communication link with the electronic device;
means for receiving the pointer over the communication link;
means for facilitating the retrieval of the control software from the remote source; and
a memory for storing the control software.

10. A wireless communication device as claimed in claim 9, wherein the means for facilitating the retrieval of the control software from the remote source comprise internet connection means.

11. A wireless communication device as claimed in claim 9, wherein the means for facilitating the retrieval of the control software from the remote source comprise an interface for connecting the wireless communication device to a further electronic device operative to receive the pointer through the interface, to retrieve the control software from the remote source and to provide the wireless communication device with the control software.

12. A method as claimed in claim 1, wherein the step of connecting the wireless communication device to the remote source comprises:
providing a further communication device for communicating with the remote source;
providing an interface for interfacing between the wireless communication device and the further communication device; and
connecting the wireless communication device to the remote source via the interface and the further communication device.
